(19) United States
(12) Patent Application Publication
(10) Pub. No.: US 2026/0038239 A1
(43) Pub. Date: Feb. 5, 2026

(54) SYSTEM AND METHOD FOR PROCESSING AN IMAGE

(71) Applicant: Mindplus AI Limited, Kowloon (CN)

(72) Inventors: Syed Muhammad Tariq Abbasi, Kowloon (CN); Hing Lam Chang, Kowloon (CN)

(21) Appl. No.: 19/275,207

(22) Filed: Jul. 21, 2025

(30) Foreign Application Priority Data
Aug. 5, 2024 (HK) 32024095140.2

(51) Int. Cl. G06V 10/764; G06T 7/11; G06V 10/40; G06V 20/70

(52) U.S. Cl. CPC G06V 10/764; G06T 7/11; G06V 10/40; G06V 20/70

(57) ABSTRACT

A system and method for processing an image including an image gateway adapted to receive one or more input images, a learning network configured to perform feature extraction on the one or more input image, and; simultaneously perform a classification function and a segmentation function on the input image.

### TECHNICAL FIELD

The present invention relates to a system and method for processing an image. In particular, the present invention relates to a system and method for processing an image by performing classification and segmentation.

### BACKGROUND

Machine learning involves utilizing a computer's ability to learn from existing data. Convolutional neural networks (CNNs) represent a classic type of machine learning, where a model is created to mimic the brain's functioning. Different inputs corresponding to various parameters generate a response and output. CNNs have been applied in many different applications.

Deep neural networks (DNNs) represent another machine learning approach. Deep neural networks rely on many parameters to achieve the desired output. These parameters may not have direct real-life meanings and depend on the computational power of modern computers to be processed effectively. Deep neural networks have found extensive applications in the medical field, particularly in medical imaging. In image processing, especially in the medical imaging context, DNNs are used for two main purposes: a) classification and b) segmentation.

Classification involves assigning a single label to an entire image, indicating its subject matter. Segmentation involves dividing the image into distinct parts and identifying which objects they belong to.

Traditionally separate DNNs are used for classification and segmentation. Using separate DNNs for classification and segmentation on a single image can results in inconsistent outcomes and inaccuracies. Another issue with using isolated models for each task, is that the isolated models lack the ability to interact with each other and mutually benefit from one another.

The traditional approach of using separate DNNs for classification and segmentation also can present additional issues. For example, a large amount of data is required to train and develop reliable models that can be effectively deployed for practical situations. Additionally, a large of computing resources, in particular graphical processing units (GPUs) are required at all deployment locations of the model. Finally, privacy concerns arise when a centralised model is accessed publicly over the internet by different parties.

### SUMMARY OF THE INVENTION

The present invention relates to a system and method for processing an image by simultaneously performing classification and segmentation of the image. The simultaneous classification and segmentation generates a labelled image. The classification output may be utilised as part of the segmentation process. The labelled image may comprise a label for each structure identified within the input image. Structures within the input image may be labelled or identified. In one example, the labelled image may comprise a segmentation map that delineates regions or structures within the input image.

The present invention relates to use of a learning network e.g., a deep learning model that is adapted to simultaneously perform segmentation and classification. The model is adapted to generate a classification output and the classification output is used as part of the segmentation process. Each class may be assigned segmentation labels for corresponding images.

In accordance with a first aspect, there is provided a system for processing an image comprising:
an image gateway adapted to receive one or more input images,
a learning network configured to:
   perform feature extraction on the one or more input image, and;
   simultaneously perform a classification function and a segmentation function on the input image.

In one example the learning network is adapted to generate a labelled image as an output of the segmentation function, wherein the labelled image comprises labels for each identified or delineated structure within each image.

In one example the learning network is configured to:
generate one or more feature maps as data flows through the learning network,
wherein the feature maps are intermediate outputs of the learning network,
store or cache the one or more feature maps in a dedicated memory buffer.

In one example the learning network is configured to apply a classification function to the one or more feature maps to derive a classification output.

In one example the learning network is configured to:
concatenate the one or more feature maps and the classification output together,
share the concatenated feature maps and the classification output to a segmentation module or segmentation layers of the learning network, and;
perform a segmentation function on the feature maps and/or input images and generate a segmentation output.

In one example the learning network is adapted to integrate the classification output and the segmentation output to produce a labelled image as an output.

In one example the classification output informs the segmentation function by providing context or conditional information that refines the segmentation output such that the segmentation function delineates regions in an image based on the classification output.

In one example the learning network is a deep learning network comprising a pipeline architecture, the learning network comprising a plurality of stages and each stage comprises one or more convolution layers, and the outputs from each stage are passed onto the next stage.

In one example the learning network comprises:
a feature extraction stage adapted to receive input images and perform feature extraction to capture essential features in the input image,
a classification branch attached to an intermediate layer of the network, the classification branch comprising fully connected layers that are adapted to process one or more feature maps by applying a classification function to generate a classification output, and;
a segmentation stage adapted to perform a segmentation function and generate a segmentation output.

In one example the learning network comprises a segmentation head that is adapted to generate a segmentation map and wherein the segmentation head comprises a convolution layer that includes a number of channels to match the number of classes or regions to be segmented.

In one example the number of classes correspond to the classification output.

In one example each stage comprises one or more convolution layers and the learning network is adapted to store intermediate outputs at the end of each stage, wherein the intermediate outputs are stored in a dedicated memory buffer.

In one example the one or more images are OCT (optical coherence tomography) scans, and the system is adapted to identify one or more ocular diseases of conditions from the labelled image.

In one example the system is configured to:
segment specific layers of a retina in an OCT image and label the specific layers of the OCT image that correspond to an ocular disease generated as a classification output, and;
the learning network configured to output a labelled image comprising labels of specific layers indicative of an ocular disease.

The system as described herein is advantageous because it allows quick and efficient processing of OCT images to identify ocular diseases within the images. The system may be a system for processing an image to identify ocular diseases.

In accordance with a second aspect, there is provided a computer-implemented method for processing an image, comprising:
receiving one or more input images, via an image gateway,
performing feature extraction on the one or more input images,
simultaneously performing classification function and a segmentation function on the one or image input images, and;
generating a labelled image, wherein the labelled image comprises labels for each identified or delineated structure within each image.

In one example, the method comprising the steps of:
generating one or more feature maps as data flows through the learning network,
wherein the feature maps are intermediate outputs of the learning network,
storing or caching the one or more feature maps in a dedicated memory buffer, and;
applying a classification function to the one or more feature maps to derive a classification output.

In one example the method comprising the steps of:
concatenating the one or more feature maps and the classification output together,
sharing or passing the concatenated feature maps and the classification output to a segmentation module or segmentation layers of the learning network,
performing a segmentation function on the feature maps and/or input images and generate a segmentation output, and;
integrating the classification output and the segmentation output to produce a labelled image as an output.

In one example the classification output informs the segmentation function by providing context or conditional information that refines the segmentation output such that the segmentation function delineates regions in an image based on the classification output.

In one example the one or more images are OCT (optical coherence tomography) scans, and the method is adapted to identify one or more ocular diseases of conditions from the labelled image.

In one example, the method comprising the steps of:
segmenting specific layers of a retina in an OCT image and label the specific layers of the OCT image that correspond to an ocular disease generated as a classification output, and;
outputting a labelled image comprising labels of specific layers indicative of an ocular disease.

In accordance with a further aspect, there is provided a machine learning network (or machine learning model) for processing an image, in particular for use in the method of any one of the statements above, comprising:
a feature extraction stage adapted to receive input images and perform feature extraction to capture essential features in the input image,
a classification branch attached to an intermediate layer of the network, the classification branch comprising fully connected layers that are adapted to process one or more feature maps by applying a classification function to generate a classification output, and;
a segmentation stage adapted to perform a segmentation function and generate a segmentation output,
wherein each stage may comprise one or more convolution layers,
a segmentation head that is adapted to generate a segmentation map and wherein the segmentation head comprises a convolution layer that includes a number of channels to match the number of classes or regions to be segmented.

In one example the number of classes correspond to the classification output.

In one example each convolution layer may be interconnected to layers preceding and following it.

In one example, the machine learning model may be a deep learning model comprising a pipeline architecture.

In accordance with a further aspect, the present invention relates to a computer-implemented method for processing an image, comprising:
receiving one or more input images, via an image gateway,
performing feature extraction on the one or more input images,
performing classification function and a segmentation function on the one or image input images,
generating a labelled image, wherein the labelled image labels each structure identified within the image.

In one example the method comprises the steps of:
extracting and storing a classification output, and;
feeding the classification output into the segmentation function.

In one example the classification output is adapted to provide context or conditional information to the segmentation function.

In one example the method is adapted to simultaneously perform the classification function and segmentation function.

In one example, the method comprises the steps of:
generating feature maps, wherein the feature maps are intermediate outputs,
caching or storing an output tensor or output feature map into a dedicated memory buffer.

In one example the method comprises the step of:
implementing layer hooks during forward pass to extract the intermediate output.

In one example the method comprises the steps of:
processing the intermediate output by applying a classification function to generate a classification output,
wherein the classification function is performed in parallel to the segmentation function, and;
   feeding the feature maps into the segmentation function.

In one example, the step of performing a segmentation function comprises the steps of:
receiving the feature maps,
receiving the classification output,
concatenating the classification output and the feature maps,
processing the concatenated classification output and feature maps by applying the segmentation function to generate a labelled image.

In one example the method steps are performed by a learning network, wherein the learning network comprising a plurality of convolution layers, a segmentation head and a classification branch, wherein the classification branch is adapted to generate the classification output, and; wherein the segmentation head adapted to generate a segmentation output.

In one example the one or more images are OCT (optical coherence tomography) scans.

In accordance with a further aspect, there is provided a system for processing an image comprising:
a computing apparatus comprising a processor and a memory unit, wherein the computing apparatus is configured to:
   receive one or more input images, via an image gateway,
   perform feature extraction on the one or more input images,
   perform classification function and a segmentation function on the one or image input images,
   generate a labelled image, wherein the labelled image labels each structure identified within the image.

In one example the computing apparatus is configured to:
extract and storing a classification output, and;
feed the classification output into the segmentation function.

In one example the classification output is adapted to provide context or conditional information to the segmentation function.

In one example the computing apparatus is adapted to simultaneously perform the classification function and segmentation function.

In one example the computing apparatus is configured to:
generate feature maps, wherein the feature maps are intermediate outputs,
cache or store an output tensor or output feature map into a dedicated memory buffer.

In one example the computing apparatus is configured to implement layer hooks during forward pass to extract the intermediate output

In one example the computing apparatus is configured to:
process the intermediate output by applying a classification function to generate a classification output,
wherein the classification function is performed in parallel to the segmentation function, and;
feed the feature maps into the segmentation function.

In one example the computing apparatus is configured to:
receive the feature maps,
receive the classification output,
concatenate the classification output and the feature maps,
process the concatenated classification output and feature maps by applying the segmentation function to generate a labelled image.

In one example the system comprises a learning network adapted to:
receive the one or more input images,
performing feature extraction on the one or more input images,
performing classification function and a segmentation function simultaneously, on the one or image input images,
generating a labelled image, wherein the labelled image labels each structure identified within the image, and
wherein the learning network comprising a plurality of convolution layers, a segmentation head and a classification branch, wherein the classification branch is adapted to generate the classification output, and; wherein the segmentation head adapted to generate a segmentation output.

In one example the one or more images are OCT (optical coherence tomography) scans, and the system is adapted to identify one or more ocular diseases of conditions from the labelled image.

In accordance with a further aspect, there is provided a machine-learning model for image processing, in particular for use in the method of any one of statements above, comprising:
a first stage adapted to perform feature extraction,
an intermediate stage adapted to generate a classification output of the image, wherein the classification output provides labels for one or more objects detected within the entire image,
a final stage adapted to perform segmentation of the image and generate a segmentation output, wherein the segmentation output comprises an indication of an object in each image segment.

In accordance with a further aspect, there is provided a data processing apparatus for processing an image, in particular for processing OCT scans comprising a means for carrying out the method of any one of statements above.

In accordance with a further aspect, there is provided a computer program comprising instructions which, when the program is executed by a computer, cause the computer to carry out the method as per any one or more of the statements earlier.

In accordance with a further aspect, there is provided a computer-readable medium comprising instructions which, when executed by a computer, cause the computer to carry out the method as per any one or more of the statements earlier.

The term “comprising” (and its grammatical variations) as used herein are used in the inclusive sense of “having” or “including” and not in the sense of “consisting only of”.

The terms “learning network”, “learning model”, “machine learning model”, “machine learning network” may be interchangeably used to define an AI model or machine learning model that is executed on a computing apparatus.

It is to be understood that, if any prior art information is referred to herein, such reference does not constitute an admission that the information forms a part of the common general knowledge in the art in any other country.

### BRIEF DESCRIPTION OF THE DRAWINGS

Embodiments of the present invention will now be described, by way of example, with reference to the accompanying drawings in which:

FIG. 1 illustrates a block diagram of a system for processing an image in accordance with one embodiment of the present invention;

FIG. 2 illustrates a schematic diagram of a computing apparatus that is implemented as a system for processing an image.

FIG. 3 illustrates a block diagram of one example embodiment of a learning network that is used as part of the system for processing an image.

FIG. 4 illustrates a block diagram of another example embodiment of a learning network that is used as part of the system for processing an image.

FIG. 5 illustrates flow chart of a method for processing an image in accordance with an embodiment of the present invention.

FIG. 6 illustrates an input OCT scan of a normal eye and a labelled image of the normal eye.

FIG. 7 illustrates an OCT scan of a person suffering from AMD (aging related macular degeneration) and a labelled image outputted by the learning network of a person suffering from AMD.

FIG. 8 illustrates an OCT scan of a person suffering from DME (diabetic macular edema) and a labelled image outputted by the learning network of a person suffering from DME.

### DETAILED DESCRIPTION OF THE PREFERRED EMBODIMENTS

The present invention relates to a system and method for processing an image by performing classification and segmentation. In particular, the present invention relates to a system and method for processing ocular images (i.e., images of the eye) by performing classification and segmentation to identify one or more ocular diseases. The ocular images may be optical coherence tomography scans.

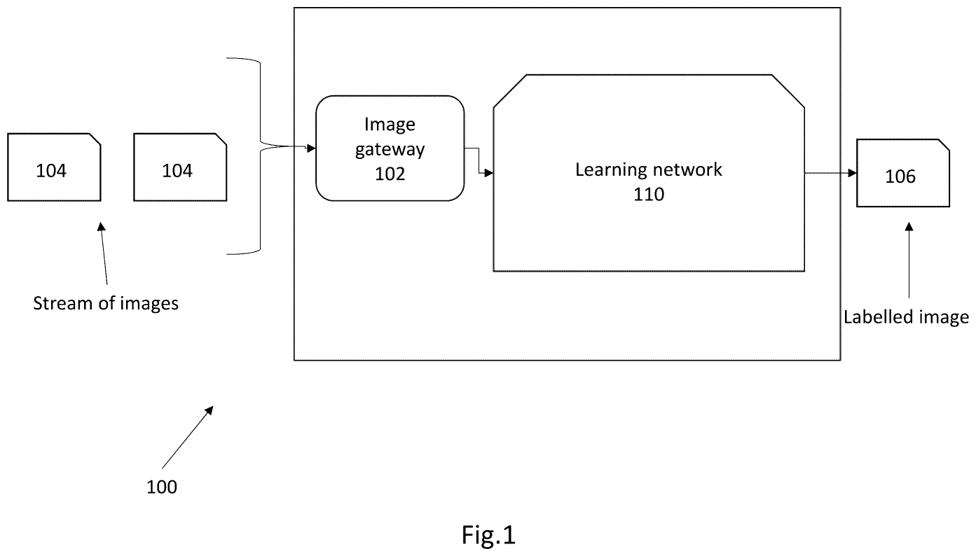

Referring to FIG. 1, an embodiment of the present invention is illustrated. This embodiment is arranged to provide a system 100 for processing an image comprising:
an image gateway 102 adapted to receive one or more input images 104,
a learning network 110 configured to:
   perform feature extraction on the one or more input image, and;
   simultaneously perform a classification function and a segmentation function on the input image.

In one example the learning network 110 is adapted to generate a labelled image as an output of the segmentation function, wherein the labelled image 106 comprises labels for each identified or delineated structure within each image.

In one example the learning network is configured to: generate one or more feature maps as data flows through the learning network, wherein the feature maps are intermediate outputs of the learning network, store or cache the one or more feature maps in a dedicated memory buffer.

In one example the learning network 110 is adapted to integrate the classification output and the segmentation output to produce a labelled image 106 as an output. The classification output informs the segmentation function by providing context or conditional information that refines the segmentation output such that the segmentation function delineates regions in an image based on the classification output.

The image gateway 102 may be arranged in communication with the learning network 110 such that received images are passed from the image gateway to an input stage or input module of the learning network 110. In one example, the image gateway 102 may perform pre-processing such as denoising of the input images.

In one example, the input images may be optical coherence tomography (OCT) scans, and the system 100 is adapted to identify one or more ocular diseases of conditions from the labelled image. The labelled image may be used to identify various ocular diseases such as for example, Age related Macular Degeneration (AMD) or Diabetic Macular Edema (DME). The system and method described herein may be particularly suited to perform classification and segmentation on OCT scans to identify ocular diseases. The learning network 110 described herein is particularly suited to generate a labelled image i.e., an image segmentation map that segments or delineates layers of a retain in an OCT image to identify ocular diseases such as AMD or DME.

In this example embodiment, the system 100 for processing an image may be implemented by a computing apparatus 200 having an appropriate user interface. The learning network 110 may be stored on and executed by a computing apparatus 200. The computing apparatus 200 may form the system for processing an image.

The computing apparatus 200 may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

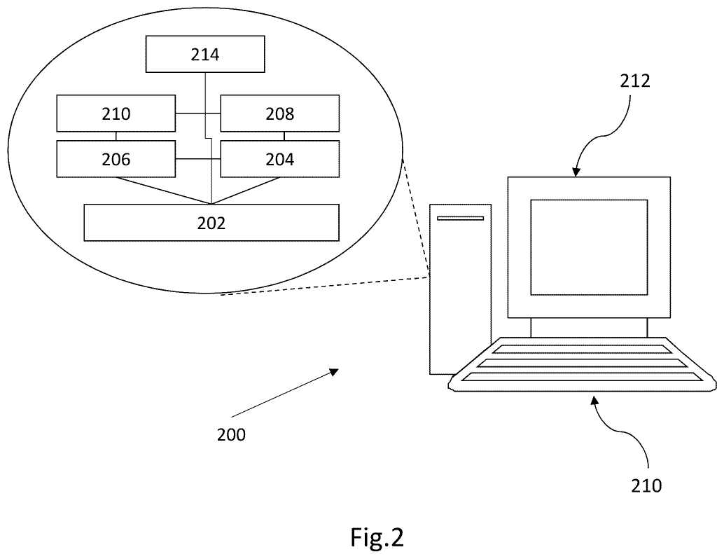

As shown in FIG. 2 there is a shown a schematic diagram of a computing apparatus 200 or computing device or computer server which is arranged to be implemented as an example embodiment of a system for processing an image. In particular, the computing apparatus 200 is arranged to be implemented as a system for processing an OCT image to identify one or more ocular diseases.

In this embodiment comprises a computing apparatus 200 which includes suitable components necessary to receive, store and execute appropriate computer instructions. The components may include a processing unit 202, including Central Processing Unit (CPU), Math Co-Processing Unit (Math Processor), or Tensor processing unit (TPUs) for tensor or multi-dimensional array calculations or manipulation operations, read-only memory (ROM) 204, random access memory (RAM) 206, and input/output devices such as disk drives 208, input devices 210 such as an Ethernet port, a USB port, etc.

Optionally, the computing apparatus may comprise a display 212 such as a liquid crystal display, a light emitting display or any other suitable display and communications links 214. The computing apparatus 200 may include instructions that may be included in ROM 104, RAM 206 or disk drives 208 and may be executed by the processing unit 202. There may be provided a plurality of communication links 214 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The computing apparatus 200 may include storage devices such as a disk drive 208 which may encompass solid state drives, hard disk drives, optical drives, magnetic tape drives or remote or cloud-based storage devices. The apparatus 200 may use a single disk drive or multiple disk drives, or a remote storage service. The computing apparatus 200 may also have a suitable operating system which resides on the disk drive or in the ROM of the apparatus 200.

The computer or computing apparatus 200 may also provide the necessary computational capabilities to operate or to interface with a machine learning network, such as a neural networks or convolution neural networks or deep learning networks, to provide various functions and outputs. In one example, the computing apparatus 200 is configured to provide computational capabilities to implement the learning network 110. The learning network 110 may be implemented locally, or it may also be accessible or partially accessible via a server or cloud-based service. The machine learning network may also be untrained, partially trained or fully trained, and/or may also be retrained, adapted or updated over time.

The learning network 110 is trained to perform simultaneous segmentation function (i.e., segmentation task) and classification function (i.e., classification task) on an input image. The classification output from the classification function may be integrated into the segmentation function such that the classification output informs or guides the segmentation function by providing context or conditional information that refines the segmentation output. The segmentation function is adapted to delineate regions of an image based on the classification output.

The learning network 110 (i.e., model) is constructed based on a segmentation model e.g., a standard segmentation model, with additional parameters allocated specifically for the classification function (classification task). The majority of the hidden parameters (i.e., intermediate outputs) are shared between the classification function and segmentation function which allows them to learn from a common foundation and enhance the output.

During training the learning network 110 is configured to receive input images, along with their classification labels and segmentation labels. The learning network 110 is trained to generate both the classification output and a segmentation output (e.g., a segmentation map) simultaneously using a single output. The learning network 110 is further adapted to extract and store intermediate outputs that may be stored in a memory or a buffer.

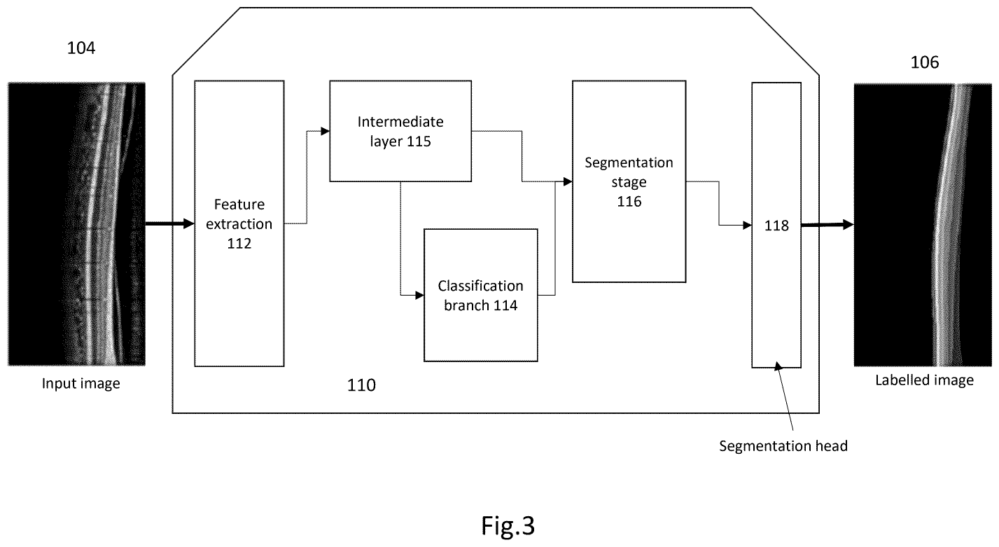

FIG. 3 illustrates an example form of a learning network 110 that is used as part of the system for processing an image. In one example the learning network 110 may comprise a feature extraction stage 112, a classification branch 114, a segmentation stage 116 and a segmentation head 118. Each stage may comprise one or more convolution layers. The learning network 110 may comprise a pipeline architecture. Input data e.g., input images such as OCT images are passed linearly and processed by the network 110.

The feature extraction stage 112 is adapted to receive input images and perform feature extraction to capture essential features in the input image 104. The classification branch 114 attached to an intermediate layer 115 of the network 110. The classification branch comprising fully connected layers that are adapted to process one or more feature maps by applying a classification function to generate a classification output. The segmentation stage 116 is adapted to perform a segmentation function and generate a segmentation output. The segmentation head 118 is adapted to generate a segmentation map and wherein the segmentation head comprises a convolution layer that includes a number of channels to match the number of classes or regions to be segmented.

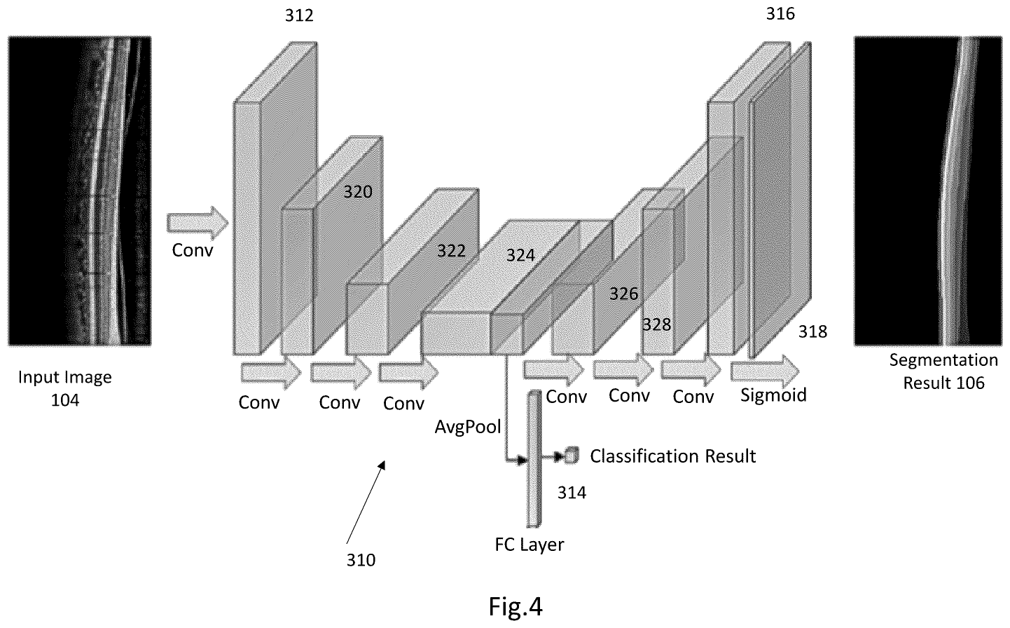

FIG. 4 illustrates a further example of a learning network 310. The learning network 310 maybe a deep learning model comprising a pipeline architecture. The learning network 310 comprises a linear architecture.

The learning network 310 is configured to: perform feature extraction on the one or more input image, and; simultaneously perform a classification function and a segmentation function on the input image. The learning network 310 is adapted to integrate a classification output and the segmentation output to produce a labelled image 106 as an output. The classification output informs the segmentation function by providing context or conditional information that refines the segmentation output such that the segmentation function delineates regions in an image based on the classification output.

In one example the learning network 310 is adapted to generate a labelled image as an output of the segmentation function, wherein the labelled image comprises labels for each identified or delineated structure within each image.

The learning network 310 comprises an initial feature extraction stage 312. The feature extraction stage 312 comprises at least one layer. The network 310 (i.e., model 310) comprises a plurality of intermediate layers 320, 322, 324, 326, 328. The intermediate layers may comprise convolution layers. The layers 320-328 may be arranged in a linear manner.

The learning network 310 comprises a classification branch 314. In the illustrated example, the classification branch 314 is attached to intermediate layer 324. The classification branch 314 may comprise a branch network and is designed to perform a classification function (i.e., a classification operation). The branch 314 comprises fully connected layers. The branch 314 is adapted to process the intermediate outputs and generate a classification output. The classification branch 314 is configured to operate in parallel to the subsequent stages of the learning network 310.

The learning network 310 further comprises a segmentation layer 316 (i.e., segmentation stage). The segmentation stage 316 is adapted to perform a segmentation function and generate a segmentation output. The segmentation layer 316 may comprise one or more convolution layers. The segmentation head 318 is the final layer of the network i.e., the final layer of the pipeline. The segmentation head 318 produces a segmentation map through a convolution layer that reduces the number of channels to match the number of classes identified in the classification output or reduces the number of channels to match the regions to be segmented.

Referring to FIG. 4, the operation of the learning network 310 will be described in more detail. Input images e.g., OCT scans are received at one end of the model 310. The data e.g., input images flows linearly through the model 310. The pipeline like flow allows for efficient and continuous processing of the input data e.g., input OCT images. The outputs of each stage are seamlessly passed onto the next stage in the model 310 (i.e., network 310). The input data undergoes several stages of processing.

Initially raw OCT scans i.e., input images are fed into the first stage i.e., the feature extraction stage 312. The feature extraction stage 312 is adapted to perform initial feature extraction. This stage may comprise convolution layers that capture the essential features of the input image.

The data is passed through the various intermediate layers 320, 322, 324, 326 and 328. Each layer may comprise one or more convolution layers. As the data flows through each stage of the learning network 310, intermediate outputs (also known as feature maps) are generated. The feature maps represent the processed data at various levels of abstraction. The network 310 implements Tensor Caching and/or Layer Hooks to extract and store the intermediate outputs (i.e., feature maps).

At the end of each stage, the output tensor (i.e., feature map) is cached or stored in a dedicated memory buffer. This ensures that the intermediate data is retained. The stored intermediate data can be accessed by later stages of the network 310. Additionally, or alternatively, hooks can be attached to layers. These hooks may be for example, Layer Hooks in PyTorch. These hooks capture the output of the layer during the forward pass and store it for subsequent use. This allows for a non-intrusive extraction of intermediate outputs without altering the model's architecture.

In one example the data copied and stored at each stage includes one or more of: feature maps, activation outputs and intermediate tensors. The feature maps are multi dimensional arrays representing the output of convolution layers. They encapsulate spatial and channel wise information about the input image. The activation outputs are results of applying non linear activation functions (e.g., ReLU) to the feature maps. The intermediate tensors contain processed data at various stages and are crucial for both segmentation and classification tasks.

The classification branch 314 is attached to the intermediate layer 324. The data from the intermediate layer 324 is highly representative and suitable for classification tasks. The network 310 comprises capturing the intermediate output from the intermediate layer 324. The feature map generated at layer 324 contains rich information that is highly suitable for classification.

The layer 324 may execute an average pooling function. The average pooling function is a pooling operation that calculates the average value for patches of a feature map and uses it to create a downsampled feature map.

The branch 314 comprises a branch network that processes the intermediate output and generates a classification output. The branch 314 may execute a classification function to generate a classification output. The branch 314 operates in parallel with the remaining segmentation stages.

The intermediate features used for classification are shared with subsequent layers e.g., the layers that handle segmentation. The sharing of the intermediate outputs ensures that the classification and segmentation functions (i.e., classification and segmentation) tasks benefit from the same underlying representation of the input data.

The data is passed to the convolution layers defining the segmentation stage 316. The data may be processed in the segmentation stage 316 and the classification branch 314 in parallel. The feature maps from one or more intermediate stages are fed into subsequent convolution layers that further process the data to generate detailed segmentation maps. These layers refine the spatial information to accurately delineate different structures within the input images (e.g., the OCT scans).

The classification output from the branch 314 is passed to the segmentation stage 316. The classification output influences the segmentation process by providing context or conditional information that can refine the segmentation output.

In optional example, the classification output is concatenated with the intermediate data (i.e., feature maps) before passing the concatenated data to the segmentation stage 316. The concatenation fuses features. The fusion ensures that the segmentation process i.e., segmentation function is informed by the classification output.

The segmentation head 318 is configured to produce a segmentation map, typically through a convolution layer. The convolution layer of the segmentation head 318 reduces the number of channels to match the number of classes from the classification output or match the regions to be segmented. As shown in FIG. 4, the output is a labelled image 106. The labelled image 106 comprises labels for each identified or delineated structure within each image. The segmentation head 318 may execute a sigmoid function to produce an output.

The learning network 310 may be used as part of the system for processing an image 100. The learning network 310 may be used to process OCT scans and delineate or segment layers within the OCT scans that are indicative of various structures. The classification output may be integrated with the segmentation output to generate an overall output. The combined classification and segmentation output can be used to identify one or more ocular diseases by segmenting or delineating layers or structures in an OCT indicative of an ocular disease.

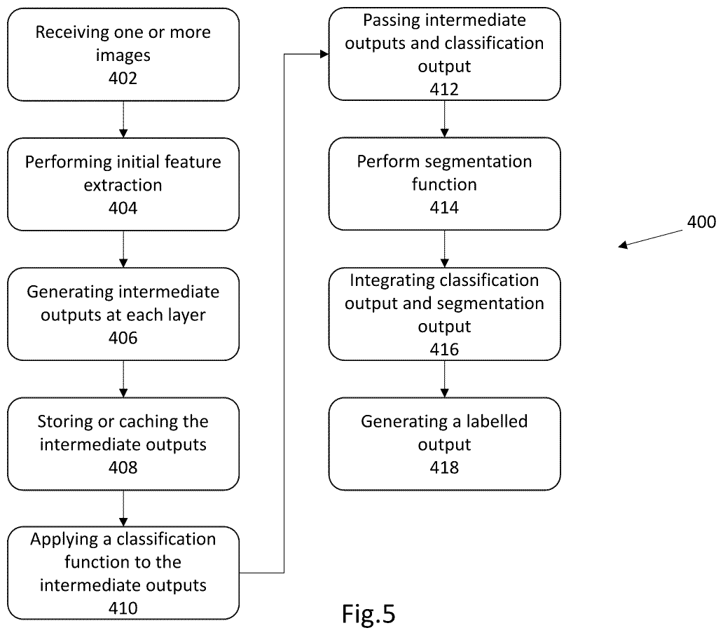

Referring to FIG. 5, there is illustrated a method of processing an image 400. The method of processing an image may be particularly suited for processing OCT scans and identify regions in the OCT scans that may be indicative of an ocular disease. The method 400 may be executed by the computing apparatus 200. The method 400 comprises step 402. Step 402 comprises receiving one or more input images. Step 404 comprises performing initial feature extraction. Step 406 comprises generating intermediate outputs (i.e., feature maps) at each layer. The input data may be processed through multiple convolution layers to generate intermediate outputs.

Step 408 comprises storing or caching the intermediate outputs. The output e.g., feature map at each intermediate layer 320-328 may be cached or stored in a dedicated memory buffer. In one example the data stored at the end of each stage may comprise feature maps, activation outputs and intermediate tensors. The feature maps may comprise multi-dimensional arrays representing the output of convolution layers and encapsulate spatial and channel wise information of the input image. The activation outputs are results of applying non linear activation functions to the feature maps. The intermediate tensors contain processed data at various stages and are used for segmentation and classification.

Step 410 comprises applying a classification function to one or more stored intermediate outputs to generate a classification output. The classification function may be applied within a classification branch 314 as described above. Step 412 comprises passing one or more of the stored intermediate outputs and the classification output to the segmentation stage (i.e., segmentation layers). Step 412 comprises concatenating one or more stored feature maps (intermediate outputs) and the classification output. The concatenated feature maps and classification output are shared to a segmentation module or segmentation layers.

Step 414 comprises performing a segmentation function on the inputs to the segmentation stage to generate a segmentation output. Step 416 comprises integrating the classification output and the segmentation output. The classification result influences the segmentation process by providing context or conditional information that can refine the segmentation output. Step 418 comprises generating a labelled image as an output. The method of processing an image 400 may be executed by the system 100 and by the computing apparatus 200.

The system 100 and method 300 for processing an image can be used to identify ocular diseases by processing Optical Coherence Tomograph (OCT) scans or images. The system 100 is adapted to generate a labelled image that identifies abnormal features in the inputted OCT scans. For example, the system 100 can be used to process OCT scans and produce a labelled image that can be used to diagnose or identify Age-related Macular Degeneration (AMD) or Diabetic Macular Edema (DME) or other ocular diseases. The system 100 uses simultaneous classification and segmentation. The classification output is fused with intermediate outputs in a learning network and then passed into the segmentation layers. The segmentation process is informed by the classification result. This integration allows the learning network (model) and system to segment different parts of the OCT scans based on the diagnosis result obtained in the classification output. This leads to more comprehensive and accurate analysis than a single segmentation tool. The classification output informing the segmentation results in a much more accurate and faster segmentation.

For example, when diagnosing AMD the model will segment only the first two layers of the retina in the OCT image. However, when diagnosing DME the model (learning network) will segment all seven layers that are affected by the disease. The specific regions to be segmented are informed by the classification output generated.

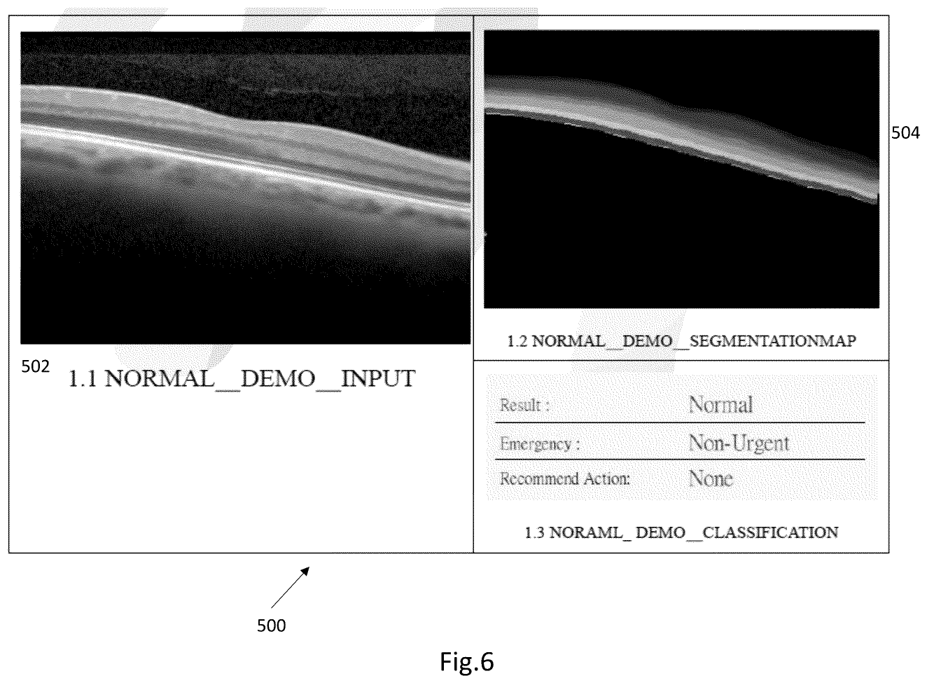

FIGS. 6 to 8 illustrate input images and outputs of the system for processing an image. FIGS. 6 to 8 illustrate images of an eye and the labelled image i.e., a segmentation map that is outputted by the learning network. FIG. 6 illustrates an image 500. The image shows an OCT scan of a normal eye 502. The segmentation map i.e., labelled image 504 is shown. The various layers in the OCT scan are segmented in the labelled image. Based on the labelled image 504 (i.e., segmented image), it is clear that the patient is not suffering from ocular diseases.

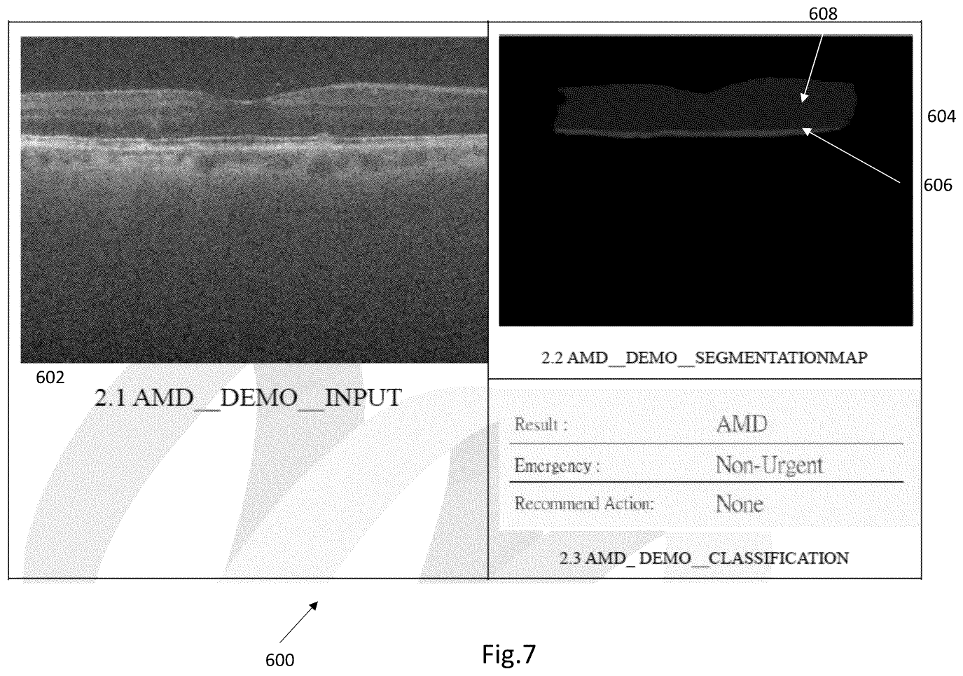

FIG. 7 illustrates an image 600 of a person suffering from AMD. The input OCT scan 602 displays multiple layers. The scan 602 is an input to the learning network. The learning network and system is adapted to process the OCT scan 602 and output a segmented image 604. In the segmented image the first two layers are segmented and identified. The segmented layers 606, 608 are illustrated on the labelled image 604. This is indicative of a patient suffering from AMD.

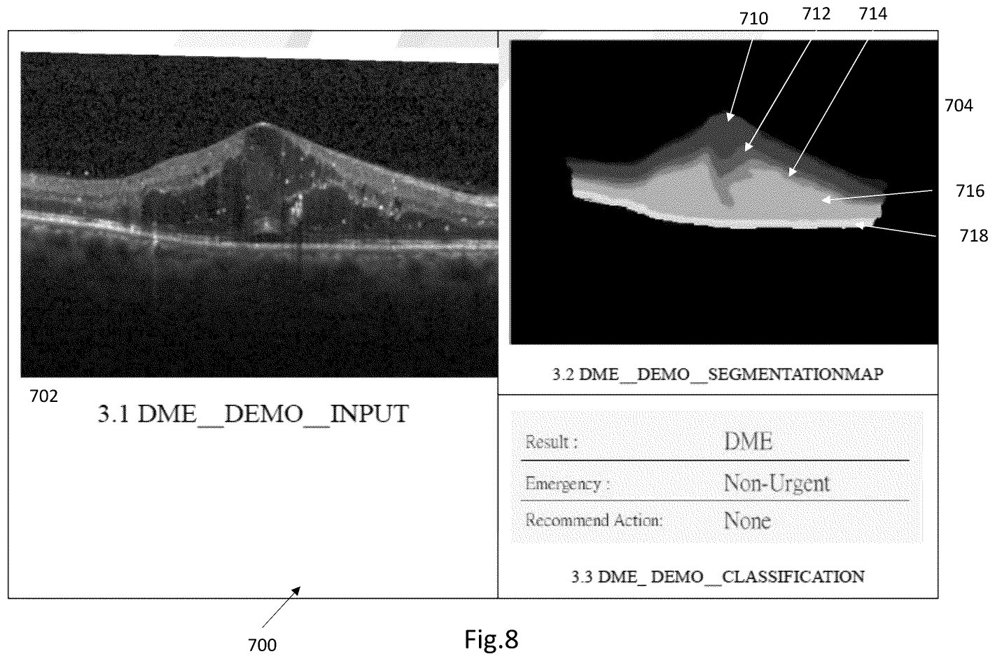

FIG. 8 illustrates an image 700 of a person suffering from DME. The input OCT scan 702 is the input image. The scan 702 is processed by the system, in particular by the learning network. The segmented image 704 is outputted by the learning network. In the segmented image at least five layers 710, 712, 714, 716 and 718 are segmented and identified. This is indicative of a patient suffering from DME.

The system 100 and learning network as described herein are advantageous because the learning network performs two tasks using a single model. The classification output is used to inform the segmentation which results in an improved overall performance. The learning network (model) is significantly lighter and faster and capable of executing the necessary tasks. The disclosed network enhances efficiency and eliminates the need for manual data processing between separate models. The currently described system and learning network eliminates the need for the computing apparatus to possess a GPU in order to execute the learning network 110, 310.

The present invention integrates the classification output with the segmentation output which provides a more accurate labelling of features in the image. The present invention combines the strengths of segmentation and classification uniquely allowing for enhanced performance and improved efficiency. The pipeline like structure ensures that data flows seamlessly through different stages enabling continuous processing while maintaining the integrity of the input information.

The system and method for processing an image is advantageous over conventional methods making it highly applicable to various fields and industries. One use is to identify and diagnose ocular diseases. The simultaneous segmentation and classification, offers significant time saving as it eliminates the need for separate processing pipelines for each task. The ability to extract the classification result from the middle section of the learning network enables more efficient integration of classification and segmentation outputs. This leads to improved overall system performance.

The learning network integrates the classification output with the segmentation allows the model (i.e., learning network) to segment different parts of the input image based on the classification result. In one example, the model can segment specific parts of the OCT scan based on the diagnosis result. This provides a more comprehensive and accurate analysis than a single segmentation tool alone. The combined classification and segmentation in a single model reduces the computational overhead.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described above may be operable or implemented on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the invention. Additional elements or components may also be added without departing from the scope of the invention. Additionally, the features described herein may be implemented in software, hardware, as a business method, and/or combination thereof.

1. A system for processing an image comprising:
an image gateway adapted to receive one or more input images,
a learning network configured to:
perform feature extraction on the one or more input image, and;
simultaneously perform a classification function and a segmentation function on the input image.

2. The system of claim 1, wherein the learning network is adapted to generate a labelled image as an output of the segmentation function, wherein the labelled image comprises labels for each identified or delineated structure within each image.

3. The system of claim 1, wherein the learning network is configured to:
generate one or more feature maps as data flows through the learning network,
wherein the feature maps are intermediate outputs of the learning network,
store or cache the one or more feature maps in a dedicated memory buffer.

4. The system of claim 3, wherein the learning network is configured to:
apply a classification function to the one or more feature maps to derive a classification output.

5. The system of claim 4, wherein the learning network is configured to:
concatenate the one or more feature maps and the classification output together,
share the concatenated feature maps and the classification output to a segmentation module or segmentation layers of the learning network,
perform a segmentation function on the feature maps and/or input images and generate a segmentation output.

6. The system of claim 5, wherein the learning network is adapted to integrate the classification output and the segmentation output to produce a labelled image as an output.

7. The system of claim 6, wherein the classification output informs the segmentation function by providing context or conditional information that refines the segmentation output such that the segmentation function delineates regions in an image based on the classification output.

8. The system of claim 7, wherein the learning network is a deep learning network comprising a pipeline architecture, the learning network comprising a plurality of stages and each stage comprises one or more convolution layers, and the outputs from each stage are passed onto the next stage.

9. The system of claim 8, wherein the learning network comprises:
a feature extraction stage adapted to receive input images and perform feature extraction to capture essential features in the input image,
a classification branch attached to an intermediate layer of the network, the classification branch comprising fully connected layers that are adapted to process one or more feature maps by applying a classification function to generate a classification output,
a segmentation stage adapted to perform a segmentation function and generate a segmentation output.

10. The system of claim 9, wherein the learning network comprises a segmentation head that is adapted to generate a segmentation map and wherein the segmentation head comprises a convolution layer that includes a number of channels to match the number of classes or regions to be segmented.

11. The system of claim 9, wherein the number of classes correspond to the classification output.

12. The system of claim 11, wherein each stage of the learning network comprises one or more convolution layers and the learning network is adapted to store intermediate outputs at the end of each stage, wherein the intermediate outputs are stored in a dedicated memory buffer.

13. The system if claim 12, wherein the one or more images are OCT (optical coherence tomography) scans, and the system is adapted to identify one or more ocular diseases of conditions from the labelled image.

14. The system of claim 13, wherein the system is further configured to: segment specific layers of a retina in an OCT image and label the specific layers of the OCT image that correspond to an ocular disease generated as a classification output, and; the learning network configured to output a labelled image comprising labels of specific layers indicative of an ocular disease.

15. A computer-implemented method for processing an image, comprising: receiving one or more input images, via an image gateway, performing feature extraction on the one or more input images, simultaneously performing classification function and a segmentation function on the one or image input images, and; generating a labelled image, wherein the labelled image comprises labels for each identified or delineated structure within each image.

16. A computer-implemented method for processing an image in accordance with claim 15, further comprises the steps of:
generating one or more feature maps as data flows through the learning network,
wherein the feature maps are intermediate outputs of the learning network,
storing or caching the one or more feature maps in a dedicated memory buffer, and;
applying a classification function to the one or more feature maps to derive a classification output.

17. A computer-implemented method for processing an image in accordance with claim 16, further comprises the steps of:
concatenating the one or more feature maps and the classification output together,
sharing or passing the concatenated feature maps and the classification output to a segmentation module or segmentation layers of the learning network,
performing a segmentation function on the feature maps and/or input images and generate a segmentation output, and;
integrating the classification output and the segmentation output to produce a labelled image as an output.

18. A computer-implemented method for processing an image in accordance with claim 17, wherein the classification output informs the segmentation function by providing context or conditional information that refines the segmentation output such that the segmentation function delineates regions in an image based on the classification output.

19. A computer-implemented method for processing an image in accordance with claim 18, wherein the one or more images are OCT (optical coherence tomography) scans, and the method is adapted to identify one or more ocular diseases of conditions from the labelled image.

20. A computer-implemented method for processing an image in accordance with claim 19, the method further comprises the steps of:
segmenting specific layers of a retina in an OCT image and label the specific layers of the OCT image that correspond to an ocular disease generated as a classification output, and;
outputting a labelled image comprising labels of specific layers indicative of an ocular disease.
